(19) United States
(12) Patent Application Publication
(10) Pub. No.: US 2013/0020266 A1
(43) Pub. Date: Jan. 24, 2013

(54) Method and apparatus for water jet moving bed filtration system

(71) Applicants: Michael B. Timmons, Ithaca, NY (US); John L. Holder, Courtenay (CA)

(72) Inventors: Michael B. Timmons, Ithaca, NY (US); John L. Holder, Courtenay (CA)

(73) Assignee: HTH Engineering & Equipment Company, LLC

(21) Appl. No.: 13/385,621

(22) Filed: Feb. 27, 2012

Related U.S. Application Data
(60) Provisional application No. 61/464,033, filed on Feb. 28, 2011.

(51) Int. Cl. C02F 1/00; B01D 24/28

(52) U.S. Cl. 210/786; 210/263

(57) ABSTRACT

A process water filtration system includes a vessel (12) containing filter media units (14). Water jets (30 and 32) create movement of the filter media units (14).

### CROSS-REFERENCE TO RELATED APPLICATION AND PRIORITY INFORMATION

This application claims the benefit of co-pending, prior filed U.S. provisional application No. 61/464,033, entitled “Water Jet Moving Bed Filtration System and Its Use,” filed Feb. 28, 2011. That provisional application is hereby incorporated by reference.

### TECHNICAL FIELD OF THE INVENTION

This invention relates generally to water filtration systems, and in particular water filtration systems for filtering water from aquaculture production systems. The invention further relates to a method of filtering water from an aquaculture production system for return to the aquaculture system to further support production.

### BACKGROUND OF THE INVENTION

Nitrogen in various chemical combinations is a component of the waste products generated by rearing fish. There are four primary sources of nitrogenous wastes; urea, uric acid, and amino acids excreted by fish; organic debris from dead and dying organisms; uneaten feed and feces; and nitrogen gas from the atmosphere. Fish expel various nitrogenous waste products through gill diffusion, gill cation exchange, urine, and feces. The decomposition of these nitrogenous compounds is particularly important in intensive recirculating aquaculture systems (RAS) because of the toxicity of ammonia, nitrite, and to some extent, nitrate. The process of ammonia removal by a biological filter is called nitrification, and consists of the successive oxidation of ammonia to nitrite and finally to nitrate.

Biological treatment processes employ bacteria that grow either attached to a surface (fixed films) or that grow suspended in the water column. Almost all recirculating systems use fixed-film bioreactors, where the nitrifying bacteria grow on either a wetted or submerged media surface. The ammonia removal capacity of biological filters is largely dependent upon the total surface area available for biological growth of the nitrifying bacteria and where excessive area is provided for the colonizing bacteria, then removal rates will be proportional to the volume of media providing the surface area. For maximum efficiency, the media used must balance a high specific surface area, i.e., surface per unit volume, with appreciable void ratio (pore space) to allow minimal resistance of water flow over and through the media and ideally to be relatively self cleaning. The media used in the biofilters must be inert, non-compressible, and not biologically degradable. Typical media (each piece of the filter media is referred to herein as a filter media unit) used in aquaculture biofilters are sand, crushed rock or river gravel, or some form of plastic or ceramic material shaped as small beads, or large spheres, rings or saddles, or even more complicated geometric structures which provide maximal surface area while using minimal substrate materials. Biofilters must be carefully designed to avoid oxygen limitation or excessive loading of solids, biochemical oxygen demand, since the nitrifying bacteria must have adequate supply of oxygen for their own metabolism needs.

An ideal biofilter would remove 100% of the inlet ammonia concentration, produce no nitrite, require a relatively small footprint, use inexpensive media, require no water pressure or maintenance to operate, and would not retain or capture solids. Unfortunately, there is no one biofilter type that meets all of these goals, each biofilter has its own strengths and weaknesses and areas of best application. There are many types of biofilters that are commonly used in intensive RAS, such as submerged biofilters, trickling biofilters, rotating biological contactors (RBC's), floating bead biofilters, dynamic bead biofilters, and fluidized-bed biofilters. The most common biological filters in use today for commercial scale systems (100 ton's per year of whole fish production) are trickling filters, fluidized sand beds (FSB's), floating bead filters (FBF's), rotating biological contactors (RBC's), and moving bed bio reactors(MBBR). Each type of filter will have its proponents.

All the above biological filter types, except the trickling filter, are submerged biofilters (an RBC always has roughly half of the filter media submerged). Submerged biofilters includes a volume of biofilter medium upon which nitrifying bacteria grow. The wastewater flows in either an up-flow or a down-flow direction or a completely mixed fashion, and thus the hydraulic retention time can be controlled by adjusting the water flow rate through the reactor vessel. Solids from the culture tank can accumulate within the submerged filter, along with cell mass from nitrifying and heterotrophic bacteria. This process can eventually block the void spaces, requiring some mechanism to flush solids from the filter for successful long-term operation. Probably the most challenging aspect of operating any submerged biofilter is to keep it relatively free of accumulated bio-solids (feed, feces, bacterial flock). To provide large void spaces to prevent clogging of the filters, the media used for submerged blotters has been traditionally of large size, such as uniform crushed rock over 5 cm in diameter or plastic media over 2.5 cm in diameter. However, 5 cm diameter crushed rock would only have a specific surface area of 75 m²/m³ and a void fraction of only 40 to 50%. Random packed plastic media would also have a relatively low specific surface area of 100-200 m²/m³, but a much higher void fraction, greater than 95%. Drawbacks of this type of filter include problems of low dissolved oxygen and solids accumulation, resulting from heavy loading of organic matter and the difficulty of back flushing. Although this type of filter was promoted and used in aquaculture in the past, it has since been replaced in aquaculture due to the inherent high construction cost, biofouling problems, and operational expense. Submerged filters have moved away from using aggregate medias, except in the case of fluidized sand beds that use finally controlled sand sizes, by using synthetic structured media with high surface area, high void ratios, and low weight.

The moving bed bioreactor (MBBR) is a more recent technology being used in the aquaculture industry. The MBBR was developed in Norway in the early 1980's to reduce nitrogen discharge from municipal waste treatment plants into the North Sea (FIG. 1). A significant advantage in upgrading existing wastewater treatment plants was its small footprint and low maintenance in comparison to the operational and maintenance issues associated with trickling filters and rotating biological contactors. MBBR technology is currently widely used in European wastewater treatment facilities and in both small and large scale commercial aquaculture operations.

The MBBR is an attached growth biological treatment process based on a continuously operating, non-clogging biofilm reactor with low head loss, a high specific biofilm surface area, and no requirement for backwashing. The bacterial biomass grows on the media carriers and moves freely in the water volume of the reactor. The reactor can be operated under either aerobic conditions for nitrification or anoxic conditions for denitrification. For nitrification the media is maintained in constant circulation via a course air bubble aeration system creating aerobic conditions and for denitrification via a submerged mixer for anoxic conditions.

This type of biofilter, uses small (usually ˜7 to 10 mm in diameter and length) slightly buoyant polyethylene porous media (specific gravity ˜0.90 to 0.95). There are many variations of this type of media in the market, but all are slightly buoyant and have very high void fractions (as mentioned ˜95% or more; see, Rusten, G., et al. Water Environm. Res. 70:1083-1089, 1998). The media is kept in motion by using a heavy level of aeration, e.g., usually something between 5 to 15 reactor volumes per hour of airflow. The tubular media typically has both internal and external ribs for enhanced surface area and a protected divided interior section to protect the biofilm from being completely stripped off during agitation in the moving bed. The heavy aeration keeps the bed in constant motion, which minimizes dissolved oxygen problems and solids accumulation. These biofilters report low total energy use and a high nitrification rate. The effective surface area for bacterial growth is around 350 m²/m³ and will have total ammonia nitrogen (TAN) removal rates of 0.3 to 1.2 kg TAN/m³/day, depending upon temperature and inlet TAN concentration. One advantage of this type of biofilter is its low hydraulic head and self aeration and providing some carbon dioxide stripping as a result of air being used to move the media; its disadvantage is the large aeration requirement to maintain the bed in motion.

In a MBBR, media can occupy up to 70% of the reactor volume (normally 50% fill), where too high of a percentage fill reduces mixing efficiency. The media is kept within the reactor volume by a) an outlet sieve or screen, which may be vertically mounted, b) rectangular mesh sieves, or c) cylindrical bar sieves, vertically or horizontally mounted. The media most often used (Kaldnes K1) is made of high-density polyethylene (density 0.95 g/cm³) and shaped as a small cylinder with a cross on the inside of the cylinder and ‘fins’ on the outside. Other media has also been used, although all have the characteristic of a protected area for biofilm growth.

Agitation (primarily by air jets) within the reactor maintains the media in constant motion creating a scrubbing effect that prevents clogging and sloughs off excess biomass. Since MBBR's are an attached growth process, treatment capacity is a function of the specific surface area of the media. This is often reported as the specific surface area of the reactor, equal to the total surface area of the media divided by the volume of the reactor, or the media specific surface area multiplied by the fraction of the total reactor volume that the media occupies. In some cases, the total surface area of the media that is available for biofilm development divided by the volume of the reactor is used, reflecting the significant abrasion of biofilm from the outer surface of some media types. For Kaldnes K1 media, the specific biofilm surface area is 500 m²/m³ and at 50% fill: 250 m²/m³ and at 70% fill: 350 m²/m³. A model for predicting nitrification rates in MBBRs was developed by Rusten et al. (Rusten, B., Hem, L. J., Ødegaard, H., 1995, Nitrification of municipal wastewater in moving-bed biofilm reactor, Water Environ. Res. 67 (1), 75-86). For TAN as the rate limiting substrate (i.e. normally for most aquaculture systems), the following equation described the nitrification rate:

r_{N}=k(S_{N})ⁿ (1)

where r_{N}=nitrification rate, g TAN/m³-day
k=reaction rate constant (1.3)
S_{N}=TAN concentration in the reactor, mg-N/L
n=reaction order constant (0.7)

A reaction order constant of n=0.7 was established by Hem et al. (Hem, L. J., Rustin, B., Ødegaard, J., 1994, Nitrification in a moving bed biofilm reactor, Water Res. 28(6), 1425, 1433.) and the reaction rate constant (k) will depend upon the wastewater characteristics, temperature and other parameters that influence the growth of nitrifying organisms (Rusten, B., Eikebrokk, B., Ulgenes, Y., Lygren, E., 2006, Design and operations of the Kaldnes moving bed biofilm reactors, Aquacult. Eng. 35, 322-331). FIG. 6 shows the nitrification rate as a function of substrate TAN concentration at 24° C. based on data from (Rusten, B., Hem, L. J., Ødegaard, H., 1995, Nitrification of municipal wastewater in moving-bed biofilm reactors, Water Environ. Res. 67 (1), 75-86). For aquaculture systems, MBBR nitrification rates per m³ of media on the order of 200 g/m³-day for broodstock (<0.3 mg-N/L), 400 g/m³day for fingerling (<0.5 mg-N/L) and 800 g/m³day for growout (<1.0 mg-N/L) can be expected.

Trickling biofilters operate in the same way as submerged biofilters, except the wastewater flows downward over the medium and keeps the bacteria wet, but never completely submerged. Since the void spaces are filled with air rather than water, the bacteria never become oxygen-starved. Trickling filters have been widely used in aquaculture, because they are easy to construct and operate, are self-aerating and very effective at removing gaseous carbon dioxide, and have a moderate capital cost. In municipal waste water treatment systems, trickling filters were traditionally constructed of rocks, but today most filters use plastic media, because of its low weight, high specific surface area (100-300 m²/m³) and high void ratio (>90%). A range of trickling filter design criteria has been reported. Typical design values for warm water systems: media depth of 1-5 m; media specific surface area of 100-300 m²/m³; and TAN removal specific area removal rates of 0.2 to 1.2 g/m² per day surface area. Trickling biofilters have not been used in large-scale coldwater systems, probably due to the decrease in nitrification rates that occurs at the lower water temperatures and the relatively low specific surface area of the media. They have found a use in smaller hatchery systems where loads tend to be low and variable.

Rotating biological contactors (RBC's) operate by rotating the biofilter media, consisting of disks or tubes, through a tank containing the wastewater. Bacteria attached to the rotating medium are exposed alternately to the wastewater and the atmosphere, which provides oxygen to the biofilm. The medium is typically submerged at a level of 40% of the drum diameter and is rotated at a speed of 1.5-2.0 rpm. Rotating biological contactors have seen some use in fully recirculating systems, because they require little hydraulic head, have low operating costs, provide gas stripping, and can maintain a consistently aerobic treatment environment. In addition, they tend to be more self-cleaning than static trickling filters. The main disadvantages of these systems are the mechanical nature of its operation and the substantial weight gain due to biomass loading of the media and the resultant load on the shaft and bearings. Early efforts using RBC's often employed under-designed shafts and mechanical components, which resulted in mechanical failure, but a properly designed RBC can be functional and reliable.

The floating bead filter has become a popular biofilter for the treatment of small or moderate flows, usually less than 1,000-2,000L/min. Floating bead filters are expandable granular filters that display a bioclarification capability similar to sand filters (Malone, R. F. & Beecher, L. E., Aquacult. Eng, 22; 57-73, 2000). They function as a physical filtration device or clarifier by removing solids, while simultaneously encouraging the growth of desirable bacteria. They also remove dissolved wastes from the water through biofiltration. Floating bead filters are resistant to biofouling and generally require little water for backwash. The bead filter is typically either bubble-washed or propeller-washed during its backwashing procedure, which expands the bed and separates trapped solids from the beads. The beads used are food-grade polyethylene with a diameter of 3-5 mm and a specific gravity of 0.91, and a moderate specific surface area of 1150-1475 m²/m³. Bead filters advantages include their modular and compact design, ease of installation, and operation. In addition, they can be used as a hybrid filter for both solids removal and nitrification. Bead filters using propeller-washed back-flushing have been built with bead volumes of up to 2.8 m³. Most small-scale systems use the bubble-washed filters, typically less than 0.28 m³.

Fluidized-bed biofilters have been used in several large-scale commercial aquaculture systems (15 m³/min to 150 m³/min or 400 to 4,000 gpm). Their chief advantage is the very high specific surface area of the media, usually graded sand or very small plastic beads. The fluidized-bed biofilter can easily be scaled to large sizes, and are relatively inexpensive to construct per unit treatment capacity. Since the capital cost of the biofilter is roughly proportional to its surface area, fluidized-bed biofilters are very cost competitive and are relatively small in size compared to other types of biofilters (Summerfelt, S. T., in CIGR Handbook Agric. Eng. pp. 309-350 (CIGR, Series Ed., Wheaton, F., Volume Ed.), AM. Soc. Agric. Eng. (1999)). The main disadvantages of fluidized-bed biofilters are the high cost of pumping water through the biofilter and that a fluidized-bed biofilter does not aerate the water, as do trickling towers and RBCs. Additional disadvantages are that they can be more difficult to operate and can have serious maintenance problems, usually due to poor suspended solids control and biofouling.

In fluidized-beds, water flows through the void spaces in the sand medium, either upward or downward, depending upon the specific gravity of the medium. The bed becomes fluidized when the velocity of the water through the bed is sufficiently large to suspend the medium in the velocity stream, causing the bed to expand in volume. The resulting turbulent motion of the medium provides excellent transport of dissolved oxygen, ammonia-nitrogen and nitrate-nitrogen to the biofilm and shears off excess biofilm. The result is high nitrification capacity in a relatively compact unit, but at the cost of the high energy required to fluidize the filter medium. The major advantage of fluidized-sand biofilters is their ability to be scaled to capacities to assimilate ammonia production from standing fish biomasses on the order of 50,000 kg. In effect, the fluidized-sand biofilters can be made as large as they need to be to handle a specified fish biomass. Other considerations will dictate the actual fish load, with the primary one being risk associated with catastrophic failure. All of the above biological filters are designed to perform the same function of oxidizing

ammonia and nitrite to nitrate. Thus, the biological filter must be designed to fully oxidize the nitrogen equivalents present in the ammonia produced, with an additional safety margin to account for unforeseen events. From a practical perspective, the biofilter selection is less critical in small production systems, i.e., systems that feed at rates below 50 kg per day, than for larger production systems. In small systems, biofilters can be overdesigned and the added cost is generally not of critical importance to the overall economic success of the venture. Each biofilter described above has advantages and disadvantages that need to be considered during the early design phase. One of the chief advantages of both the trickling biofilter and the RBC is that they both add oxygen to the water flow during normal operation. In addition, they provide some carbon dioxide stripping. In contrast, the submerged biofilters, bead filters, and fluidized-bed biofilters are all net oxygen consumers and rely completely on the oxygen in the influent flow to maintain aerobic conditions for the biofilm. If, for whatever reason, the influent flow is low in dissolved oxygen, anaerobic conditions are generated within the biofilters.

A disadvantage of the trickling and RBC biofilters is that they readily biofoul, if suspended solids are not adequately controlled. Carbon-eating heterotrophic bacteria grow 100 times faster than autotrophic nitrifiers. Their mass can double in an hour, while it takes nitrifiers days to double. This high growth rate and the associated oxygen demand consequently suffocate the nitrifiers buried deeper in the biofilms, resulting in death and sloughing of the biofilm from the bioreactor surfaces.

A limiting factor of the rate of reduction of ammonia in each pass through a biofilter is the rate of diffusion of the reactants through the biofilm. The reduction rate is thus related to the residence time of the water within the medium, e.g. if 30% of ammonia is reduced for some specific retention time, and the retention time is increased by a factor two, then 30% of the remaining ammonia will be reduced or 30%+30%×70% i.e. a total of 51% of the incoming concentration for doubling the retention time.

Therefore, a need has arisen for an improved filter and filtration system.

### SUMMARY OF THE INVENTION

In accordance with the teachings of the present invention, improved filter methods and apparatus are provided. In particular, a filtration system for filtering process water is provided which includes a filter through which the process water flows, the filter comprising a plurality of filter media units. At least one water jet is in fluid communication with the filter, and the water jet has a flow rate sufficient to move at least some of the filter media units.

The system may also include a plurality of water jets positioned so as to move at least some of the filter media units in a rotating flow. In one particular embodiment, the filter is located in a vessel, the vessel having a width that is approximately twice its depth.

In one embodiment, a plurality of water jets are centrally located near the bottom of the vessel and oriented in substantially opposite horizontal directions. Such an embodiment may be used to move at least some of the filter media units in two rotating flows.

In still another embodiment, a plurality of water jets are centrally located near the top of the vessel and oriented to move at least some of the filter media units in two rotating flows.

In one particular mode of operation, which includes water jets near the top and the bottom of the vessel, the water jets located near the bottom of the vessel are inoperative at least part of the time the water jets located near the top of the vessel are operative, and the water jets located near the top of the vessel are inoperative at least part of the time the water jets located near the bottom of the vessel are operative.

Also provided is a method of filtering process water that includes filtering the process water through a plurality of filter media units and moving at least some of the filter media units with at least one water jet.

In a particular method, at least some of the filter media units are moved in a rotating flow. Also, in one embodiment, the filtering may occur in a vessel having a width that is approximately twice its depth.

In a particular method, moving at least some of the filter media comprises moving at least some of the filter media with a plurality of water jets centrally located near the bottom of the vessel and oriented in substantially opposite horizontal directions. In one embodiment, at least some of the filter media units are moved in two rotating flows.

In another embodiment, at least some of the filter media is moved in two rotating flows with a plurality of water jets centrally located near the top of the vessel.

In one mode of operation, the water jets located near the bottom of the vessel and the water jets located near the top of the vessel are alternately operated.

In another embodiment, a filtration system for filtering process water is provided that includes a vessel through which the process water flows. Filter media are located in the vessel, with the filter media comprising a plurality of filter media units that filter the process water. Also provided is at least one water jet in fluid communication with the filter media, located near the central axis of the vessel. This water jet has a flow rate sufficient to move at least some of the filter media units and creates a flow that moves at least some of the filter media units from the center of the vessel upward and radially outward, then down along sidewalls of the vessel. The direction of the water jets may also be reversed.

It is an objective of the present invention to provide an improved filtration system for filtering water. The filtration system comprises at least one chamber or reaction vessel that contains a water inlet, means for distributing water, and a water outlet. For optimal results, the geometry of the reaction vessel is particularly critical and should maintain a width to depth ratio of two along the long axis of the vessel. The invention is specifically advantageous over existing designs used for moving bed bio reactors (MBBR), which use pressurized air to fluidize or move the biomedia. The water jet MBBR uses small jets of water to accomplish the mixing requirement and therein accrues substantial energy savings in doing so and eliminates most practical constraints on the sizing and scaling of such units.

A further objective of the invention is to provide a method of purifying water, especially water from an aquaculture system. The method includes the steps of providing contaminated water to the filtration system of the invention, and the removal of purified water from the filtration system.

The invention further provides a water recirculation system which is based on the filtration system of the invention. The water recirculation system comprises at least one aquaculture tank, means for supplying process water from the tank to the filtration system for filtering, a filtration system according to the present invention (which includes water jets separate from the process water flow path), and means for supplying filtered water from the filtration system to the at least one aquaculture tank. The system therefore provides recirculation of water, such that contaminated water from the aquaculture is filtered by the filtration system of the invention, and delivered back into the aquaculture. Additional means typically used in water recirculation systems may optionally be present, such as pumping means, means for aeration of water, additional filtering means such as means for removing solid particles from the water.

### BRIEF DESCRIPTION OF THE DRAWINGS

Reference is made in the description to the following briefly described drawings, wherein like reference numerals refer to corresponding elements:

FIGS. 1 and 2 illustrates a preferred embodiment of a water jet (WJ) MBBR according to the teachings of the present invention;

FIGS. 3 and 4 illustrate a particular mode of operation that alternates between a mode 1 and mode 2 operating sequence;

FIGS. 5a and 5b illustrate another embodiment of the present invention; and

FIG. 6 is a graph of the influence of TAN concentrations on TAN removal in a Kaldnes MBBR at 24° C.

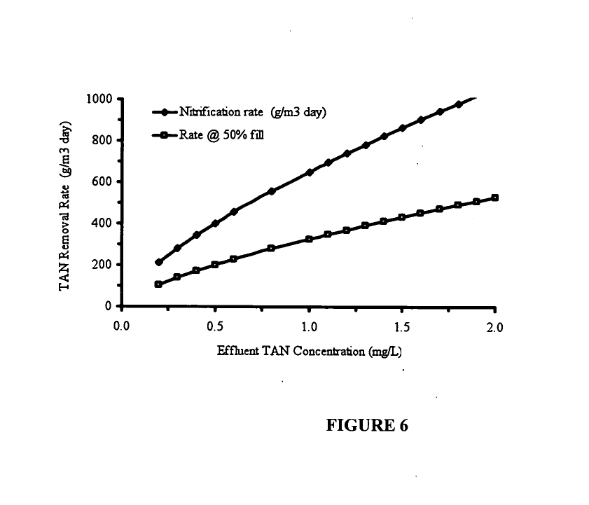

### DETAILED DESCRIPTION OF THE INVENTION

The invention, which we refer to as a water jet moving bed biofilter (WJ-MBBR), dramatically reduces electrical pumping and treatment costs of aquaculture type waters used in a recirculation mode of operation. The reduced energy is due to using water jets as opposed to pressurized airflow to fluidize and mobilize the media within the mixing vessel, the biological reactor or MBBR. Since the water jets have no buoyancy relative to the reactor vessel, the direction of flow in the WJ-MBBF can be periodically reversed to minimize problems with biofilter media bunching that results in that media becoming inactive and much less energy is used in moving the media using the water jets compared to mixing being created by air jets and flotation. Use of air jets also forces a conventional MBBR to operate in only one direction, meaning the media is always following the same recurring path, i.e., up, across, down, etc., since the air is driving the media and the air is always moving from the bottom of a reactor vessel and upward. A MBBR filter removes carbon dioxide in the process of fluidizing the media, but there are much more efficient ways to remove carbon dioxide than by air stripping, e.g., surface agitators. The WJ-MBBR in combination with surface agitation for CO₂ removal and using near 100% efficient diffusers for adding oxygen to the overall system when needed, reduces energy use compared to conventional MBBR systems or other biological filter systems to less than 2 kWh per kg of whole fish produced, when applied to land based salmonid (e.g., Atlantic salmon) operation conducted at large scale, e.g., 500 ton per year of production or larger.

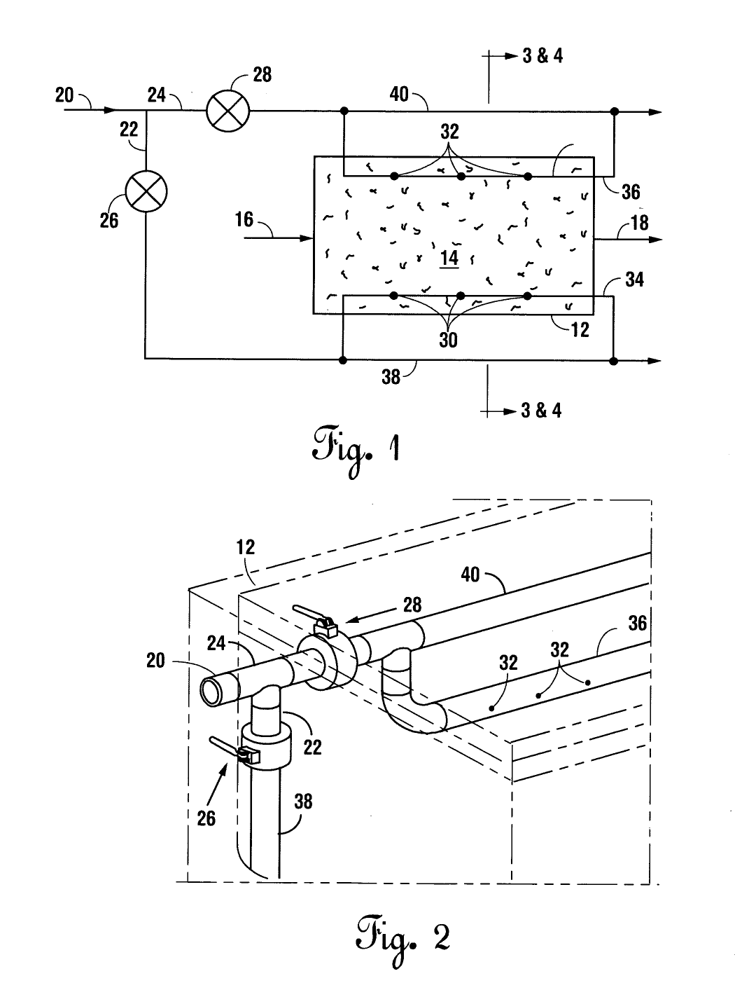

Referring now to FIG. 1, a block diagram of a cross section of one embodiment of the present invention is provided. As shown, a vessel 12 contains filter media 14. Process water is received into vessel 12 from a process water inlet 16. The process water is filtered through the filter media 14 and returned through outlet 18.

A water jet inlet 20 provides a supply of water for water jets. The water for the water jets may be process water, or any other source of water. The flow and pressure for the water jet supply water may be supplied by any suitable mechanism, including, without limitation, a pump (not shown). In a preferred embodiment, the water jet inlet water is divided into more than one flow path. In the particular embodiment shown, the water jet inlet water is divided into flow paths 22 and 24, which pass through valves 26 and 28, respectively.

Downstream of the valves 28 and 30, water jets are created through openings 30 and 32 in pipes 34 and 36, respectively. Openings 30 and 32 may be sized as appropriate for the application. The openings 30 and 32 may be oriented as required for the particular application. Thus, they may be formed in the sides of the pipes 34 and 36 for horizontal water jets, or at other radial locations on the pipes for water jets that emanate at other than horizontal orientations. Although three openings 30 and three openings 32 are illustrated, this is an example only. More or fewer water jet openings may be used.

Although multiple water jet paths (22 and 24, and pipes 34 and 36) are shown, only one path is necessary. Similarly, although valves 26 and 28 are illustrated, no valves are necessary. As will be discussed in more detail below, the valves 26 and 28 allow for a preferred approach of alternating movement of the filter media. However, no such alternating movement is necessary.

FIG. 1 also illustrates header lines 38 and 40. These header lines may be periodically coupled to the water jet pipes 34 and 36, respectively, to create substantially constant pressure along the water jet pipes 34 and 36, to create effective water jet pressure along the entire length of the water jet pipes. This is particularly beneficial for long runs of water jet pipes. However, no such headers are required. FIG. 2 illustrates a portion of FIG. 1 in detail.

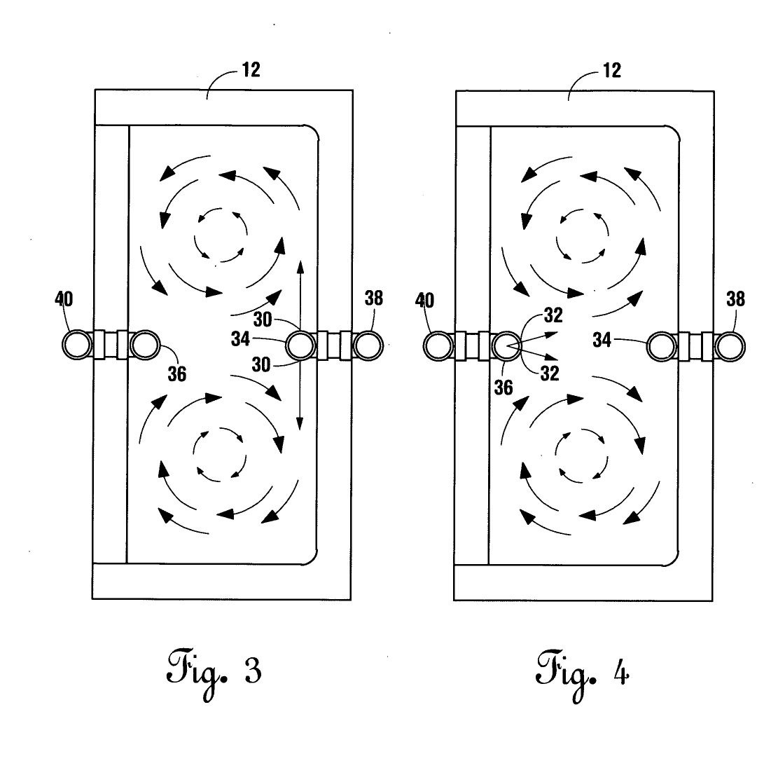

In the WJ-MBBR, for optimal results, the geometry of the reactor vessel is critical as is the placement of the water jets that are used to fluidize/mobilize the media. The WJ-MBBR takes advantage of the physical principle that rotating masses of fluid tend to break or form into circular rotating masses of fluid, which minimizes shear stress on the rotating mass; once a mass of rotating fluid exceeds an aspect ratio of ˜1.5, the rotating mass will break into two rotating masses so that the aspect ratio returns to nearer 1.0 (a rotating cylinder of fluid would have an aspect ratio of 1 for the cross section). For this reason, the WJ-MBBR reaction vessel (where the nitrification occurs) is designed to have a width to depth ratio of approximately (˜) 2, so that the mixed flow (with properly oriented inlet jets) will result in two counter-rotating masses of fluid, each with a long axis that parallels the long dimension of the mixing vessel. We introduce the water jets to create such a rotating flow, which consists of two parallel cylindrical rotating masses of fluid, with each rotating mass rotating counter to its parallel mate, see FIGS. 3 and 4 and arrows indicating flow direction; note that each of these figures demonstrates one of two possible operating modes of the particular embodiment.

In practice, the WJ-MBBR may operate for long or short periods of time in either mode, and the modes need not be operated for equal lengths of time. The major objective and advantage of the WJ-MBBR is that alternating modes and flow direction will prevent media bunching (clumping) if it were to occur. A conventional air-operated MBBR does not have the ability to do this in any practical way, since air is always pushing up in the same direction.

The water jets can be supplied in a variety of manners and any one design approach here is not critical to the successful operation of a WJ-MBBR. In a preferred embodiment, a series of slots are provided in each of the water distribution pipes. Alternative methods are using a series of holes that provide round water jets. Hole or slot sizes are established based upon a user's criteria to minimize hole plugging by fish scales or other debris; a typical hole or slot size would be 5 to 10 mm.

A sample set of design calculations is provided below (Table 1). These calculations are for a 100 kg of feed per day being fed into a set of fish tanks that produce ammonia in proportion to this feed loading level. The sample calculation shows the required water jet flow is ˜6% of the hydraulic loading imposed on the MBBR vessel that is necessary to maintain ammonia levels in the fish tanks at or below their design target levels.

TABLE 1
MOVING BED DESIGN: HYDRAULICS

1. Determine the volume of media requ'd, and assume the MBBF will be 50% filled with media
2. Assume a maximum depth of water in the moving bed
3. Require the width of the bed = 2x the water depth
4. Determine Length of Moving Bed Vessel
5. From Dimensions, then calculate the Wetted Area (A)

| | | | |
|---|---|---|---|
| Feeding load, kg/day | 100 | Approximate Flow Required on Fish Tank system | |
| Protein Content | 45% | TAN in fish tanks, mg/L | 1 |
| TAN Load, kg/day | 4.14 | Efficiency of TAN removal, % | 33% |
| Unit Nitrification Rate, g TAN/m3/d | 600 | Requ'd Flow Rate, m3/hr | 523 |
| Fill % for media | 50% | as GPM | 2,300 |
| Volume of Vessel, m3 | 13.8 | Flow rate ratio MBBF/Fish Tanks | 6% |
| Depth of Water in MBBF, m | 1.00 | | |
| Width (= 2x depth) | 2.00 | | |
| Length, m | 6.9 | | |
| Wetted area, m2 | 31.6 | | |
| Ct assigned | 0.08 | (range of 0.05 to .15) | |
| Average Velocity in MBBF, m/s | 0.3 | | |
| Jet Velocity entering the MBBF, m/s | 13 | | |
| Approx. Pressure Requ'd, m | 10.0 | (note: 10.4 m is one atmosphere of pressure) | |
| Solve for Q, m3/s | 0.0090 | | |
| .or in m3/h | 32.2 | | |
| As GPM | 142 | | |
| and as HRT on Vessel, min | 25.7 | | |

Hole and Slot Design: Assume inlet pipe runs length of the MBBF vessel

| | | |
|---|---|---|
| Percentage of inlet length that is slot | 5% | |
| Width of slot (total), cm | 0.19972 | Solve for as = Q/V = A, D = A/L |

FIGS. 3 and 4 illustrate a mode of operation that includes alternating between two flow directions in order to minimize media from collecting near top of the water column (bunching) and becoming more resistive to water flow through the media, which therein reduces the nitrification capacity of the filter. It is important to note in FIGS. 3 and 4 that the preferred geometry of the cross section of the tank is that the ratio of the width of the tank to the depth of water being maintained is approximately 2. An alternative embodiment would be where the reactor vessel has a diameter to depth ratio of one, but in this case, there would be one rotating mass of fluid where the center axis of the rotating body of fluid runs with the long dimension of the mixing vessel. Restrictions of water depth for the reactor vessel would be a primary reason why a particular diameter depth ratio were chosen.

FIG. 4 illustrates water jet direction substantially downward from the top water jet pipe 36, which results in the filter media rotating in the same direction as caused by the horizontal bottom jets of FIG. 3. This approach reduces media bunching at the top, and keeps the filter media moving. However, the water jets of pipe 36 may be oriented horizontally to reverse the flow direction of the media from that created by the bottom jets of FIG. 3.

It should be understood that the orientation of the water jets, whether in the top or the bottom of the vessel 12, may be varied depending on the particular needs of the system. Furthermore, it should be understood that, although multiple water jets are preferred, only one water jet is necessary. Also, although it is preferred that at least two rotating masses be created, the water jets may be oriented to create one rotating mass. Also, the water jet or water jets need not be positioned in the top or bottom of the vessel 12. They may be positioned anywhere in the vessel 12.

It should also be understood that the alternating operating modes discussed in connection with FIGS. 3 and 4 are examples only. Various other alternating operating modes may be used, including, without limitation, schemes that employ multiple sets of water jets from multiple water jet pipes. As an example of such a scheme, multiple valves may be controlled to alternately operate multiple sets of water jets. Each set of water jets results in different rotations or movement of the filter media. Thus, by alternately operating the valves, the movement of the filter media may me alternated, for example, and without limitation, from two rotating masses, to reversing the direction of the two rotating masses, to a single rotating mass.

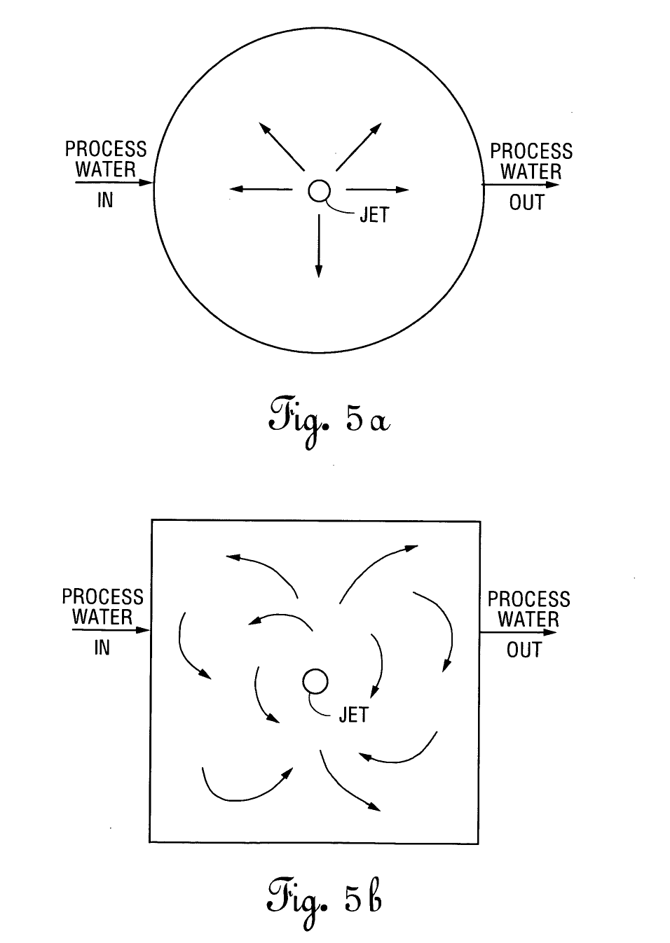

As an example of another embodiment (FIGS. 5a, 5b), one or more of the water jets are located near the central axis of a vessel, which may be cylindrical. The one or more jets create a rising plume so that the water then flows upward and radially outward and then downward (a boiling type action) forcing the media to move up and out and then downward near the vessel walls. This motion can also be reversed with water jets oriented downward. The effect of either direction is to prevent the filter media from coalescing and becoming relative motionless. This embodiment is particularly suited for small-scale reactors, e.g., less than 4 or 5 m³ in total volume. Preferably, for a cylindrical tank, the diameter of the cylinder is twice its depth.

The particular embodiments and descriptions provided herein are illustrative examples only, and features and advantages of each example may be interchanged with, or added to the features and advantages in the other embodiments and examples herein. Moreover, as examples, they are meant to be without limitation as to other possible embodiments, are not meant to limit the scope of the present invention to any particular described detail, and the scope of the invention is meant to be broader than any example. Also, the present invention has several aspects, as described above, and they may stand alone, or be combined with some or all of the other aspects.

And, in general, although the present invention has been described in detail, it should be understood that various changes, alterations, substitutions, additions and modifications can be made without departing from the intended scope of the invention, as defined in the following claims.

What is claimed is:

1. A filtration system for filtering process water, comprising:
a filter through which the process water flows, the filter comprising a plurality of filter media units; and
at least one water jet in fluid communication with the filter, the water jet having a flow rate sufficient to move at least some of the filter media units.

2. The system of claim 1, comprising a plurality of water jets, the water jets positioned so as to move at least some of the filter media units in a rotating flow.

3. The system of claim 1, wherein the filter is located in a vessel, the vessel having a width that is approximately twice its depth.

4. The system of claim 3, comprising a plurality of water jets centrally located near the bottom of the vessel and oriented in substantially opposite horizontal directions.

5. The system of claim 4, wherein the water jets move at least some of the filter media units in two rotating flows.

6. The system of claim 4, and further comprising a plurality of water jets centrally located near the top of the vessel and oriented to move at least some of the filter media units in two rotating flows.

7. The system of claim 6, wherein the water jets located near the bottom of the vessel are inoperative at least part of the time the water jets located near the top of the vessel are operative, and wherein the water jets located near the top of the vessel are inoperative at least part of the time the water jets located near the bottom of the vessel are operative.

8. The system of claim 2, wherein the water jets emanate from openings in a pipe.

9. A method of filtering process water, comprising:
filtering the process water through a plurality of filter media units; and
moving at least some of the filter media units with at least one water jet.

10. The method of claim 10, and further comprising moving at least some of the filter media units in a rotating flow.

11. The method of claim 10, and wherein the filtering occurs in a vessel having a width that is approximately twice its depth.

12. The method of claim 11, and wherein moving at least some of the filter media comprises moving at least some of the filter media with a plurality of water jets centrally located near the bottom of the vessel and oriented in substantially opposite horizontal directions.

13. The method of claim 12, wherein at least some of the filter media units are moved in two rotating flows.

14. The method of claim 12, and further comprising moving at least some of the filter media in two rotating flows with a plurality of water jets centrally located near the top of the vessel.

15. The method of claim 14, and further comprising alternating the operation of the water jets located near the bottom of the vessel and the water jets located near the top of the vessel.

16. A filtration system for filtering process water, comprising:
a vessel through which the process water flows;
filter media in the vessel, the filter media comprising a plurality of filter media units that filter the process water; and
at least one water jet in fluid communication with the filter media, the water jet located near the central axis of the vessel, wherein the water jet has a flow rate sufficient to move at least some of the filter media units and creates a flow that moves at least some of the filter media units from the center of the vessel either upward or downward and radially outward, then down or up, respectively, along sidewalls of the vessel.
